(19) United States
(12) Patent Application Publication
(10) Pub. No.: US 2024/0209239 A1
(43) Pub. Date: Jun. 27, 2024

(54) SEAM TAPE, COMPONENT MATERIAL, AND ACCESSORY MATERIAL WITH EPOXY ADHESIVE FOR INFLATABLE SAFETY PRODUCTS

(71) Applicant: Air Cruisers Company, LLC, Wall Township, NJ (US)

(72) Inventors: Thomas W. Swierkocki, Manasquan, NJ (US); Christian Thomson, Manasquan, NJ (US)

(21) Appl. No.: 18/086,898

(22) Filed: Dec. 22, 2022

(51) Int. Cl. C09J 7/30; B32B 5/02; B32B 7/12; B32B 15/08; B32B 15/18; B32B 15/20; B32B 27/08; B32B 27/32; B32B 27/34; B32B 27/36; C09J 7/24; C09J 7/28; C09J 7/29

(52) U.S. Cl. CPC C09J 7/30; B32B 5/02; B32B 7/12; B32B 15/08; B32B 15/18; B32B 15/20; B32B 27/08; B32B 27/32; B32B 27/34; B32B 27/36; C09J 7/243; C09J 7/28; C09J 7/29; B32B 2307/306; B32B 2307/3065; B32B 2307/54; B32B 2307/5825; B32B 2307/7242; B32B 2437/00; B32B 2439/46; B32B 2571/00; B32B 2605/12; C09J 2203/358; C09J 2400/163; C09J 2423/046; C09J 2463/00

(57) ABSTRACT

A seam tape, component material, and/or accessory material may be used for an inflatable safety product. The seam tape, component material, or accessory material includes an epoxy adhesive, and the epoxy adhesive adheres the seam tape, component material, and/or accessory material to a fabric or flexible material of the inflatable safety product.

### FIELD OF THE INVENTION

The field of the invention relates to seam tapes, patch materials, component materials, and accessory materials for inflatable safety products such as but not limited to inflatable evacuation slides, inflatable evacuation slide/rafts, inflatable evacuation rafts, and inflatable evacuation ramps, and inflatable evacuation slide/ramps.

### BACKGROUND

Federal aviation safety regulations require aircraft to provide evacuation and other safety provisions for passengers. These include, but are not limited to, evacuation slides, evacuation slide/rafts, ramps, slide/ramps, life rafts, life vests, helicopter floats and other life-saving inflatable devices. Relevant inflatable products can also include evacuation slides, evacuation slides/rafts, evacuation ramps, evacuation slide/ramps, aviation life rafts, marine life rafts, emergency floats, emergency flotation systems, life preservers/vests, emergency flotation devices, inflatable shelters (military and nonmilitary), ship decoys and inflatable military targets, and any other flotation devices, rescue equipment, or other safety device requiring rapid inflation and/or secure air- or gas-holding functions. These inflatable devices are generally built from an assembly of inflatable tubular structures that form airbeams that are sealed to one another. Inflatable escape slides and life rafts also have non-air-holding features, such as patches, floors, sliding surfaces, girts, handles, and other features.

Typically, in order to form the tubular structures, many pieces of fabric or flexible composite material (which may be referred to herein as panels) are joined together. Safety regulations set strength requirements for the fabric or flexible composite material itself (the field of the inflatable tube), as well as strength requirements for the seam areas. In order to keep the inflation gas inside the tubes for long durations, the seams must be sealed together to make them substantially leak proof.

Traditionally, contact adhesives or contact cements with high solvent contents have been used to bond the seam tape, component and/or accessory to the fabric or flexible material of the inflatable product. However, adhesives with high solvent contents are not environmentally friendly and pose risks to the health and safety of the workplace. Moreover, the application of solvent-based contact adhesives or contact cements to bond seam tapes, patches, and/or accessories to fabrics or flexible composite materials requires long labor hours as well as curing time after the adhesive is applied.

### SUMMARY

The terms “invention,” “the invention,” “this invention” and “the present invention” used in this patent are intended to refer broadly to all of the subject matter of this patent and the patent claims below. Statements containing these terms should be understood not to limit the subject matter described herein or to limit the meaning or scope of the patent claims below. Embodiments of the invention covered by this patent are defined by the claims below, not this summary. This summary is a high-level overview of various aspects of the invention and introduces some of the concepts that are further described in the Detailed Description section below. This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings and each claim.

According to certain embodiments of the present invention, a seam tape, component material, or accessory material for an inflatable safety product includes an epoxy adhesive to adhere the seam tape, component material, or accessory material to a fabric or flexible composite material of the inflatable safety product.

According to certain embodiments of the present invention, an inflatable safety product includes a first panel, a second panel, the first panel and the second panel forming a seam region, and the seam tape, and the seam tape joins the first panel and the second panel in the seam region.

According to certain embodiments of the present invention, a method of forming an inflatable safety product includes adhering a seam tape, component, or accessory to at least one panel of the inflatable safety product. The seam tape, component or accessory includes an epoxy adhesive adhering the seam tape, component, or accessory to the at least one panel. In some embodiments, the seam tape, component, or accessory includes an emissivity of 0.48 or less.

Various implementations described in the present disclosure can include additional systems, methods, features, and advantages, which can not necessarily be expressly disclosed herein but will be apparent to one of ordinary skill in the art upon examination of the following detailed description and accompanying drawings. It is intended that all such systems, methods, features, and advantages be included within the present disclosure and protected by the accompanying claims.

### BRIEF DESCRIPTION OF THE DRAWINGS

FIG. 1 illustrates a portion of an inflatable safety product with a seam tape, component material, or accessory material according to certain embodiments of the present invention.

FIG. 2 is a cross-sectional view of the seam tape, component material, or accessory material fabric or flexible composite material of FIG. 1.

FIG. 3 is a cross-sectional view of a seam tape, component material, or accessory material according to certain embodiments of the present invention.

FIG. 4 is an exploded view of an inflatable safety product with a seam tape, component material, or accessory material according to certain embodiments of the present invention.

FIG. 5 with a seam tape, component material, or accessory material according to certain embodiments of the present invention.

FIG. 6 is an exploded view of an inflatable safety product with a seam tape, component material, or accessory material according to certain embodiments of the present invention.

FIG. 7 is an exploded view of an inflatable safety product with a seam tape, component material, or accessory material according to certain embodiments of the present invention

FIG. 8 is an exploded view of an inflatable safety product with a seam tape, component material, or accessory material according to certain embodiments of the present invention.

FIG. 9 is an exploded view of an inflatable safety product with a seam tape, component material, or accessory material according to certain embodiments of the present invention.

FIG. 10 is an exploded view of an inflatable safety product with a seam tape, component material, or accessory material according to certain embodiments of the present invention.

FIG. 11 is an exploded view of an inflatable safety product with a seam tape, component material, or accessory material according to certain embodiments of the present invention.

FIG. 12 is an exploded view of an inflatable safety product with a seam tape, component material, or accessory material according to certain embodiments of the present invention.

FIG. 13 is an exploded view of an inflatable safety product with a seam tape, component material, or accessory material according to certain embodiments of the present invention.

FIG. 14 is an exploded view of an inflatable safety product with a seam tape, component material, or accessory material according to certain embodiments of the present invention.

FIG. 15 is an exploded view of an inflatable safety product with a seam tape, component material, or accessory material according to certain embodiments of the present invention.

### DETAILED DESCRIPTION

The subject matter of embodiments of the present invention is described here with specificity to meet statutory requirements, but this description is not necessarily intended to limit the scope of the claims. The claimed subject matter may be embodied in other ways, may include different elements or steps, and may be used in conjunction with other existing or future technologies. This description should not be interpreted as implying any particular order or arrangement among or between various steps or elements except when the order of individual steps or arrangement of elements is explicitly described.

The described embodiments of the invention provide a seam tape, component material, or accessory material for inflatable safety products. While the seam tapes, patch material, component materials, or accessory materials are discussed for use with inflatable safety products, they are by no means so limited. Rather, embodiments of the seam tapes, patch material, component materials, or accessory materials may be used in inflatable products of any type or otherwise as desired.

In various embodiments, the fabric or flexible composite materials described herein are utilized on inflatable safety equipment that is typically deflated, folded, and compressed to fit into confined areas on aircraft doors, within an aircraft fuselage, or in an aircraft storage compartment, thereby taking up space or volume on vehicles with volume restrictions such as aircraft.

Described herein are seam tapes, patch material, component materials, or accessory materials for inflatable safety products, and more particularly seam tapes, patch material, component materials, or accessory materials with epoxy adhesives for adhering the seam tapes, patch material, component materials, or accessory materials to fabric or flexible composite materials of inflatable safety products. In various embodiments and compared to traditional approaches, the epoxy adhesives described herein may adhere the seam tape, component material, or accessory material to a metallic surface of the inflatable safety product while maintaining radiant heat and gas barrier properties. In certain embodiments and compared to traditional approaches, the epoxy adhesives described herein may adhere the seam tape, component material, or accessory material to fabric or flexible composite material panels of the inflatable safety product having an emissivity less than or equal to 0.48, such as less than or equal to 0.25, while maintaining radiant heat and gas barrier properties.

A method of adhering a seam tape, component material, or accessory material to a fabric or flexible composite material of an inflatable product may include (i) applying an epoxy adhesive onto a seam tape, component material, or accessory material, (ii) partially curing the epoxy adhesive, (iii) optionally maintaining the epoxy adhesive on the substrate of the seam tape, component material, or accessory material at a low temperature (or freezing), (iv) positioning the seam tape, component material, or accessory material with epoxy adhesive onto the fabric or flexible composite material of an inflatable, (v) apply heat and pressure to the seam tape, component material, or accessory material, (vi) curing the epoxy adhesive, and (vii) optionally post curing the epoxy adhesive at an elevated temperature.

In various embodiments, a method may include applying a flowing epoxy adhesive (liquid state) at the interface between a fabric, a flexible composite material, a seam tape, a patch, a component, an accessory, a girt, a floor, or a sliding surface. The method may include applying heat, UV curing, and/or catalyzed curing, and applying pressure, in a continuous or discontinuous manufacturing process. The method may include heating the epoxy adhesive using hot air, an infrared heater, a heated wedge, a heated roller, applying radio frequency waves, applying microwaves, applying friction energy, and/or applying high-frequency ultrasonic acoustic vibrations until the epoxy adhesive is partially or fully cured with or without applying pressure.

In various embodiments, a method may include adhering a layer of epoxy adhesive (in a flexible state or solid state) to a fabric, a flexible composite material, a seam tape, a patch, a component, an accessory, a girt, a floor, or a sliding surface. The method may include applying heat, UV curing, and/or catalyzed curing, and applying pressure, in a continuous or discontinuous manufacturing process. The method may include heating the epoxy adhesive using hot air, an infrared heater, a heated wedge, a heated roller, applying radio frequency waves, applying microwaves, applying friction energy, and/or applying high-frequency ultrasonic acoustic vibrations until it is partially or fully cured with or without applying pressure.

The epoxy adhesives described herein allow for a seam tape, component material, or accessory material to adhere to surfaces of fabric or flexible composite material of the inflatable safety product (with or without metallic surfaces) without needing contact adhesives or contact cements with high solvent contents.

Advantageously, the seam tapes, patch material, component materials, or accessory materials with epoxy adhesives allow for the seam tape, component material, or accessory material to be adhered to a panel of the inflatable product having an emissivity of less than or equal to 0.48, such as less than or equal to 0.25, while maintaining seam adhesion and gas barrier properties. An emissivity of 0 would mean that the fabric or flexible composite material reflects all heat, and a temperature of the fabric or flexible composite material would not significantly change when exposed to radiant heat. Conversely, an emissivity of 1 would mean that the fabric or flexible composite material is a perfect absorber, and all the heat would be absorbed. In some embodiments, the seam tape, component material, or accessory material may have an emissivity of less than or equal to 0.48. In certain embodiments, the seam tape, component material, or accessory material may have an emissivity of less than or equal to 0.25.

Various other advantages and benefits may be realized with the systems and methods described herein, and the aforementioned benefits should not be considered limiting.

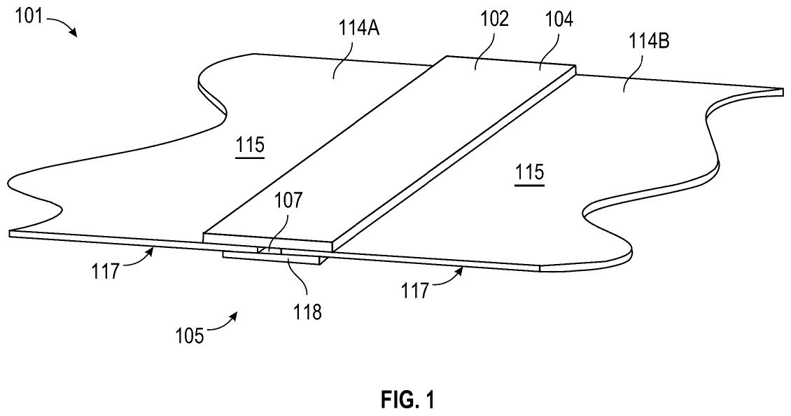

FIG. 1 illustrates an example of a portion of an inflatable safety product 101 according to embodiments. The inflatable safety product 101 generally includes at least one fabric or flexible composite material panel 114 and a seam tape, component material, or accessory material 102. The at least one fabric or flexible composite material panel 114 generally includes an outer surface 115 and an inner surface 117, and the seam tape, component material, or accessory material 102 is adhered to at least one of the outer surfaces 115 or the inner surface 117 of the at least one fabric or flexible composite material panel 114.

In the embodiment illustrated, the inflatable safety product 101 includes two fabric or flexible composite material panels 114—a first fabric or flexible composite material panel 114A and a second fabric or flexible composite material panel 114B. In various embodiments, at least one of the fabric or flexible composite material panels 114A-B has an emissivity of less than or equal to 0.48, and in certain embodiments, at least one of the fabric or flexible composite material panels has an emissivity of less than or equal to 0.25. In some embodiments, both fabric or flexible composite material panels 114A-B have the same emissivity, although they need not in other embodiments. As a non-limiting example, both fabric or flexible composite material panels 114A-B may have an emissivity of less than or equal to 0.48, such as less than or equal to 0.25.

The fabric or flexible composite material panels 114 may have various constructions. In one non-limiting example, each fabric or flexible composite material panel 114 includes a substrate and one or more layers on the substrate. The substrate may be constructed from various materials such as but not limited to polyethylene, ultra-high molecular weight polyethylene, polypropylene, polyester, polyamide, aromatic polyamide, aramid, polyolefin, aromatic polyester, polyarylate, other liquid crystal polymers, or nylon, other suitable substrate material, and/or any combination thereof. As additional non-limiting examples, the substrate of the fabric or flexible composite material panels 114 may be a material such as but not limited to those sold under the trade names Dyneema®, Spectra®, Innegra®, Vectran®, Technora®, Kevlar®, Nylon-6, or Nylon 6-6. The one or more layers on the substrate of the fabric or flexible composite material panels 114 includes, but is not limited to, a metallic layer, an inner layer, an exterior layer, and/or one or more adhesive and/or film layers,

The metallic layer of the fabric or flexible composite material panel 114 may be a completely covering layer of the substrate of the fabric or flexible composite material panel 114, meaning that the portions of the metallic layer are interconnected even though an entirety of the at least one surface of the substrate of the fabric or flexible composite material panel 114 is not necessarily covered. The metallic layer of the fabric or flexible composite material panel 114 may include various metals or metallic elements as desired, including but not limited to aluminum, an aluminum alloy, titanium, a titanium alloy, nickel, a nickel alloy, brass, a brass alloy, steel, a steel alloys, stainless steel or a stainless steel alloy, silver, a silver alloy, combinations thereof, or any other suitable metal or metallic alloy. In other non-limiting examples, the metallic layer of the fabric or flexible composite material panel 114 includes other types of metallic elements, such as titanium, zinc, and the like, or metallic alloys such as titanium alloys, zinc alloys, and the like.

In some embodiments, the metallic layer of the fabric or flexible composite material panel 114 is an outermost layer of the fabric or flexible composite material panel 114, although in other embodiments, the metallic layer is not an outermost layer of the fabric or flexible composite material panel 114. As a non-limiting example, a protective top layer and/or other type of top layer as desired (not illustrated) may be the outermost layer and may be positioned on the metallic layer of the fabric or flexible composite material panel 114. Optionally, and when included, the protective top layer may include a thin film layer, coating, or other suitable layer that can prevent damage, inhibit corrosion, and/or inhibit oxidation of the metallic layer of the fabric or flexible composite material panel 114. In another embodiment, the exterior layer may prevent deterioration due to hydrolysis. In another embodiment, the metallic layer of the fabric or flexible composite material panel 114 is covered by an exterior layer to promote adhesion to seam tapes, girt materials, floor materials, sliding surface materials, patch material, component materials, accessory materials, or other materials. In another embodiment, the metallic layer of the fabric or flexible composite material panel 114 is covered by an exterior layer to increase the durability of the metallic layer, fabric, or flexible composite material. In some embodiments, the protective top layer optionally includes a passivation layer, a parkerized layer, or other suitable layer that may be formed via a controlled oxidation process. When included, the exterior layer of the fabric or flexible composite material panel 114 may be various types of materials as desired. In one non-limiting example, the exterior layer of the fabric or flexible composite material panel 114 may be an acrylic coating, although in other embodiments other suitable materials may be utilized as desired. Optionally, and when included, the exterior layer of the fabric or flexible composite material panel 114 may include a thin film layer or other suitable layer.

The inner layer of the fabric or flexible composite material panel 114 may provide an air-tight or gas-tight seal for the fabric or flexible composite material panel 114 and may be constructed from various materials. As non-limiting examples, the inner layer of the fabric or flexible composite material panel 114 may include a plastic-based layer, a urethane-based layer, a metallic layer, or any other suitable layer for allowing the inflatable safety product 101 to be inflated with air or other gases.

In some embodiments, at least one of the fabric or flexible composite material panels 114A-B optionally includes a metallic layer, and the seam tape, component material, or accessory material 102 is adhered to the metallic layer as discussed in detail below. In various embodiments, at least one of the fabric or flexible composite material panels 114A-B optionally includes a non-metallic surface, and the seam tape, component material, or accessory material 102 is adhered to the non-metallic surface. The non-metallic surface may include, but is not limited to, an acrylic, nylon, polyolefin, modified polyolefin, polyurethane, vinyl, polyethylene (PE), polypropylene (PP), polyamide (PA), fluoropolymer, polyethylene terephthalate (PET), polystyrene, ethylene vinyl acetate (EVOH), polyvinylidene chloride (PVDC), polycarbonate (PC), polyvinyl chloride (PVC), polylactic acid (PLA), polyvinyl alcohol (PVOH), ethylene-chlorotrifluoroethylene, polyetherketone (PEK), polyetheretherketone (PEEK), polyetherketoneketone (PEKK), or any combination thereof, or any other suitable material where the epoxy adhesive adheres the seam tape, component material, or accessory material to the metallic and/or non-metallic surface of the fabric or flexible composite.

In the embodiment illustrated in FIG. 1, the seam tape, component material, or accessory material 102 is provided as a seam tape 104. In this example, the seam tape 104 is provided to join a seam region 105 (e.g., a butt seam) formed by the first fabric or flexible composite material panel 114A and the second fabric or flexible composite material panel 114B. As illustrated in FIG. 1, a gap 107 may be formed between the fabric or flexible composite material panels 114A-B, and the seam tape 104 may cover the gap 107. Optionally, an air holding film 118 is provided in the seam region 105 and on a surface of the panels 114A-B opposite from the seam tape 104. While the seam tape 104 is illustrated on the outer surface 115, it need not be in other embodiments. Moreover, while a single seam tape 104 is illustrated, any number of seam tapes 104 and/or other seam tape, component material, or accessory material 102 may be provided on the outer surface 115 and/or the inner surface 117 of one or more panels 114 as desired. Moreover, while the seam tape, component material, or accessory material 102 is illustrated as the seam tape 104 for the inflatable product 101, as previously mentioned, in other embodiments, the seam tape, component material, or accessory material 102 may be provided as a patch material, component material and/or an accessory material, such as but not limited to a patch, girt, handle, structural attachment, or pouch.

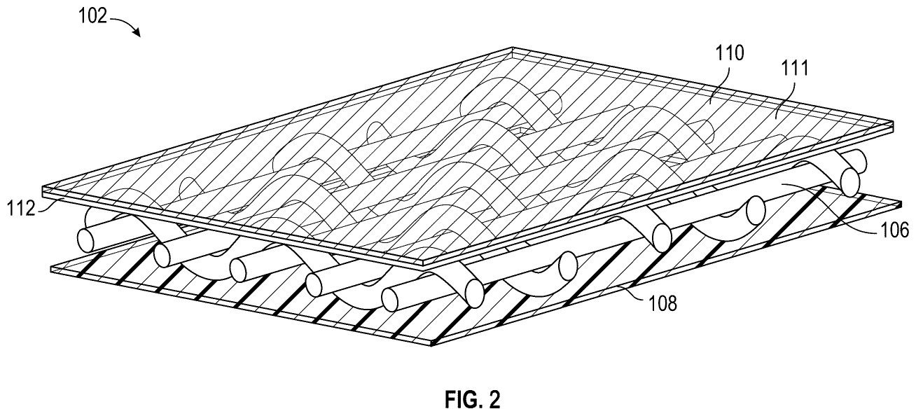

Referring to FIG. 2, the seam tape, component material, or accessory material 102 is illustrated in greater detail. As illustrated in FIG. 2, the seam tape, component material, or accessory material 102 generally includes a substrate 106 and an epoxy adhesive 108.

The substrate 106 may be various flexible composite or fabric materials as desired. As non-limiting examples, the substrate 106 may include polyethylene, ultra-high molecular weight polyethylene, polypropylene, polyester, polyamide, aromatic polyamide, aramid, polyolefin, aromatic polyester, polyarylate, other liquid crystal polymers, or nylon, other suitable substrate material, and/or any combination thereof or any combination thereof. As additional non-limiting examples, the substrate 106 may be a material such as but not limited to those sold under the trade names Dyneema®, Spectra®, Innegra®, Vectran®, Technora®, Kevlar®, Nylon-6, or Nylon 6-6. In one non-limiting example, the substrate 106 is a polyester substrate or a polyamide substrate. In other non-limiting example, the substrate 106 is a polyethylene substrate or a polypropylene substrate. In certain embodiments, the substrate 106 may be, but does not have to be, similar to a material of the substrate of the fabric or flexible composite material panel(s) 114.

The epoxy adhesive 108 may be various epoxy adhesives for adhering the seam tape, component material, or accessory material 102 to the fabric or flexible composite material panel(s) 114. In certain embodiments the epoxy adhesive is solvent-free. In certain embodiments the epoxy adhesive is a solvent-based, water-based, or solids-based epoxy adhesive. In certain embodiments the epoxy adhesive is single-part epoxy adhesive or a two-part (resin and hardener) epoxy adhesive.

In some embodiments, the epoxy adhesive 108 is activated or cured by heat and pressure. In various embodiments, the epoxy adhesive 108 is activated or cured by ultraviolet light. In certain embodiments, the epoxy adhesive 108 is a two-part epoxy that is activated by introducing a hardener during the adhering of the seam tape, component or accessory to the inflatable safety product panel or combination thereof. The seam tape, component material, or accessory material 102 may be adhered using ultrasonic welding and/or high-frequency sound waves and pressure. In certain embodiments, the seam tape, component material, or accessory material 102 is adhered using radio frequency welding and/or high-frequency electromagnetic energy and pressure. In various embodiments, the seam tape, component material, or accessory material 102 is adhered using ultraviolet light. In certain embodiments, the seam tape, component material, or accessory material 102 is adhered using hot air and pressure. Various other techniques may be used to activate or cure the epoxy adhesive 108 and/or to adhere the seam tape, component material, or accessory material 102.

In one non-limiting example, the epoxy adhesive 108 is cured using heat and obtains a seam adhesion, ply adhesion and/or seam peel strength of 1 lb/inch or greater after being exposure to a heat source for less than 5 seconds.

In one non-limiting example, the epoxy adhesive 108 remains substantially flexible after one or more methods described above are used to adhere one or more seam tapes, patch materials, component materials, or accessory materials to each other or to the fabric or flexible composite material of the inflatable safety product.

In certain embodiments, the epoxy adhesive 108 may allow the seam tape, component material, or accessory material 102 to maintain seam adhesion and/or gas barrier properties with the fabric or flexible composite material panel(s) 114 when exposed to a heat source, aging, or fluids exposure.

In various embodiments, the epoxy adhesive 108 adheres the seam tape, patch material, accessory material, or component material 102 to the fabric or flexible composite material panel(s) 114 having the emissivity of less than or equal to 0.48. In various embodiments, the epoxy adhesive 108 adheres the seam tape, patch material, accessory material, or component material 102 to the fabric or flexible composite material panel(s) 114 having the emissivity of less than or equal to 0.25. In certain embodiments, the epoxy adhesive 108 adheres the seam tape, patch material, accessory material, or component material 102 to a metallic layer of the fabric or flexible composite material panel(s) 114 and/or to a non-metallic layer of the fabric or flexible composite material panel(s) 114. In certain embodiments, the epoxy adhesive 108 adheres the seam tape, patch material, accessory material, or component material 102 to an exterior layer, coating, or film covering the metallic layer of the fabric or flexible composite material panel(s) 114. 114. In certain embodiments, the epoxy adhesive 108 adheres the seam tape, patch material, accessory material, or component material 102 to a non-metallic layer of the fabric or flexible composite material panel(s) 114.

In various embodiments, seam tapes, patch materials, component materials, and accessory materials for inflatable safety products with epoxy adhesive described herein are utilized on inflatable safety equipment that is typically deflated, folded, and compressed to fit into confined areas on aircraft doors, within an aircraft fuselage, or in an aircraft storage compartment, thereby taking up space or volume on vehicles with volume restrictions such as aircraft.

In various embodiments, the epoxy adhesive 108 adheres the seam tape, component material, or accessory material 102 to the fabric or flexible composite material panel(s) 114 having the emissivity of less than or equal to 0.48. In various embodiments, the epoxy adhesive 108 adheres the seam tape, component material, or accessory material 102 to the fabric or flexible composite material panel(s) 114 having the emissivity of less than or equal to 0.25. In certain embodiments, the epoxy adhesive 108 adheres the seam tape, component material, or accessory material 102 to a metallic layer of the fabric or flexible composite material panel(s) 114 and/or to a non-metallic layer of the fabric or flexible composite material panel(s) 114.

In certain embodiments, the seam tape, component material, or accessory material 102 with the epoxy adhesive 108 has an emissivity of less than or equal to 0.48. In other words, when subjected to radiative heat, the seam tape, component material, or accessory material 102 may reflect about 50% of the heat. In some embodiments, the seam tape, component material, or accessory material 102 with the epoxy adhesive 108 has an emissivity of less than or equal to 0.25.

In addition to the substrate 106 and the epoxy adhesive 108, the seam tape, component material, or accessory material 102 may have various other layers, as will be discussed in detail below. Such additional layers may be provided on the substrate 106 on a surface opposite from the epoxy adhesive 108, between the epoxy adhesive 108 and the substrate 106, and various combinations thereof. Moreover, the layers may be provided in various configurations or stacks of layers. Example layers are discussed in detail below, but the type and/or location of the particular layers discussed should not be considered limiting.

In the example of FIG. 2, in addition to the epoxy adhesive 108 and the substrate 106, the seam tape, component material, or accessory material 102 includes a metallic layer 110 and an adhesive layer and/or film layer 112 between the metallic layer 110 and the substrate 106.

The metallic layer 110 at least partially covers at least one surface of the substrate 106 and/or the adhesive layer and/or film layer 112. As such, while the following description makes reference to the metallic layer 110 being positioned on the surface of the substrate 106, it is by no means limited, and the description is equally applicable to the metallic layer 110 being positioned on the adhesive layer and/or film layer 112.

In various embodiments, the metallic layer 110 includes various metals or metallic elements as desired, including but not limited to aluminum, aluminum alloys, titanium, titanium alloys, nickel, nickel alloys brass, brass alloys, steel, steel alloys, silver, silver alloys, stainless steel, stainless steel alloys, combinations thereof, and/or any other suitable metal or metallic elements as desired.

In some embodiments, the metallic layer 110 is a thermoplastic polyurethane coating with metallic elements or particles dispersed within the coating. In one non-limiting example, the metallic layer 110 is a thermoplastic polyurethane coating with aluminum particles dispersed within the thermoplastic polyurethane coating. In such embodiments, the metallic layer 110 with dispersed metallic elements or particles may be considered a discontinuous metallic layer. In other embodiments, and as illustrated in FIG. 2, the metallic elements or particles are provided as a covering layer (completely covering layer or discontinuously covering layer) of the seam tape, component material, or accessory material 102. A continuously covering layer refers to a metallic layer in which the portions of the metallic layer 110 are interconnected even though an entirety of the at least one surface of the substrate 106 is not necessarily covered. In other embodiments, the metallic layer 110 may be discontinuous and/or provided at discrete locations covering at least one surface of the substrate 106.

The metallic layer 110 may be deposited on, adhered to, and/or otherwise positioned on the substrate 106 using various techniques as desired. As a non-limiting example, the metallic layer 110 may be printed on the substrate 106, may be adhered to the substrate 106 via epoxies or other adhering materials, may be deposited on the substrate 106, may be vapor-deposited on the substrate 106, or the like. In some embodiments, the metallic layer 110 is plated on the substrate 106, sputtered on the substrate, or the like. In some embodiments, the metallic layer 110 is a metallic foil layer adhered to the substrate 106.

In certain embodiments, the metallic layer 110 with the dispersed metallic particles in the coating optionally may provide a different emissivity compared to the metallic layer 110 provided as a continuous and/or completely covering layer. In some embodiments, the emissivity of the metallic layer 110 with dispersed metallic particles in the thermoplastic polyurethane coatings has an emissivity of less than or equal to 0.48, and the metallic layer 110 provided as a continuous and/or completely covering layer may have an emissivity of less than or equal to 0.25. As such, the seam tape, component material, or accessory material 102 described herein may include a tailored emissivity to reflect heat as desired when subjected to radiative heat. With the emissivity of less than or equal to 0.48, the seam tape, component material, or accessory material 102 may maintain adhesion and gas barrier properties when exposed to radiant heat.

In certain embodiments, the type of metallic layer 110 (e.g., dispersed metallic particles or provided as a completely covering layer) may depend on the material used as the substrate 106. As non-limiting examples, the dispersed metallic particles in a thermoplastic or thermoset coating may be utilized as the metallic layer 110 for substrates formed of materials having relatively increased melting points, and the metallic layer 110 provided as a completely covering layer may be utilized for substrates formed of materials having relatively decreased melting point. As a non-limiting example, a polyamide substrate or a polyester substrate may include the metallic layer 110 formed of the dispersed metallic particles in the thermoplastic or thermoset coating, and a polyethylene substrate or a polypropylene substrate may include the metallic layer 110 as a completely covering layer.

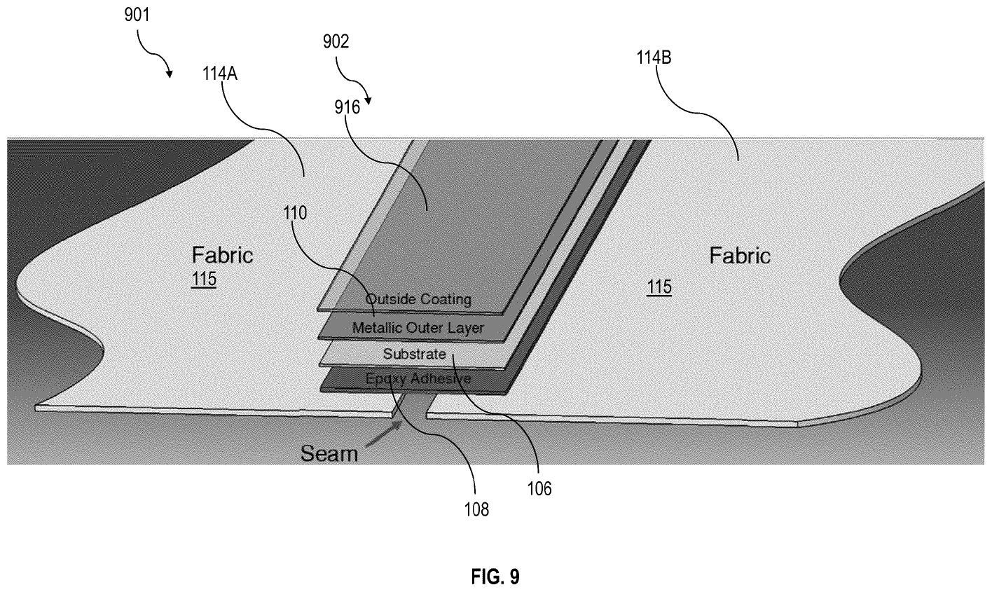

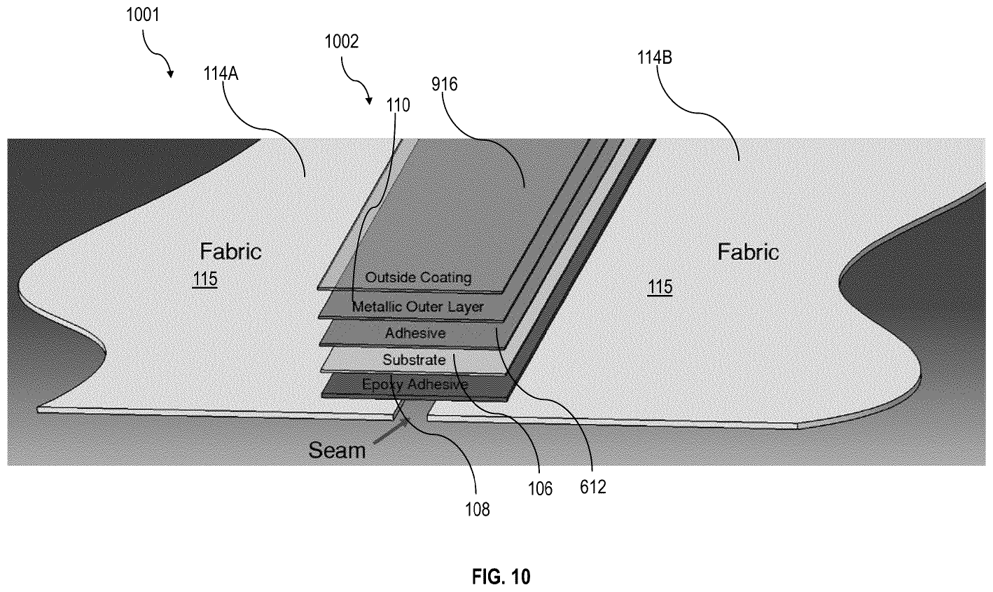

In some embodiments, the metallic layer 110 may form an outermost layer of the seam tape, component material, or accessory material 102. However, in other embodiments, and as discussed in detail below with regards to FIGS. 9 and 10, it need not be, and the metallic layer 110 optionally may be covered by an exterior layer (and the exterior layer is an outermost layer). When included, the exterior layer may be various types of materials as desired, and in certain embodiments the exterior layer may protect the metallic layer 110. In one non-limiting example, the exterior layer may be an acrylic coating, although in other embodiments other suitable materials may be utilized as desired. Optionally, and when included, the exterior layer may include a thin film layer, coating, or other suitable layer that may minimize and/or prevent oxidation or corrosion of the metallic layer 110 and deterioration of the fabric or flexible composite material due to hydrolysis. In some embodiments, the exterior layer optionally includes a passivation layer, a parkerized layer, or other suitable layer that may be formed via a controlled oxidation process.

Referring to the adhesive layer and/or film layer 112, the number and location of the adhesive layers and/or film layers 112 illustrated in FIG. 2 is for illustrative purposes only and should not be considered limiting.

The adhesive layer and/or film layer 112 may include, but is not limited to, an acrylic, nylon, polyolefin, modified polyolefin, polyurethane, vinyl, polyethylene (PE), polypropylene (PP), polyamide (PA), fluoropolymer, polyethylene terephthalate (PET), polystyrene, ethylene vinyl acetate (EVOH), polyvinylidene chloride (PVDC), polycarbonate (PC), polyvinyl chloride (PVC), polylactic acid (PLA), polyvinyl alcohol (PVOH), ethylene-chlorotrifluoroethylene, polyetherketone (PEK), polyetheretherketone (PEEK), polyetherketoneketone (PEKK), or any combination thereof, or any other suitable material.

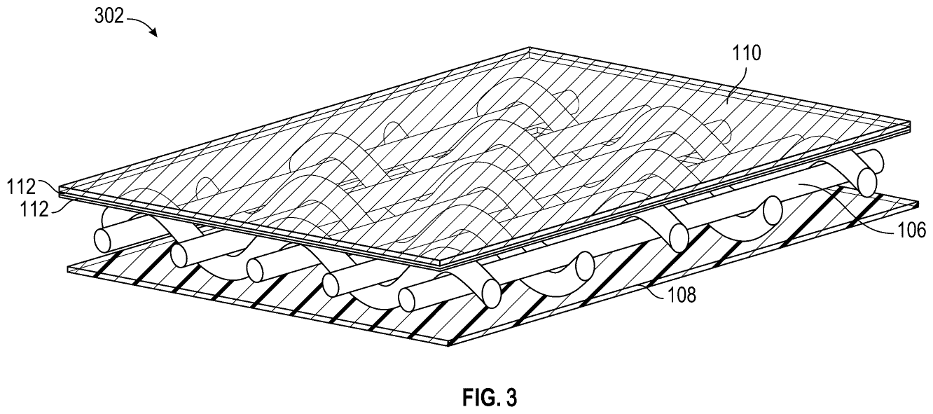

In various embodiments, a fabric or flexible composite material according to embodiments may include an adhesive layer, a film layer, or both an adhesive layer and a film layer. The adhesive layer and/or film layer 112 may be an adhesive layer and/or film, and when included, may facilitate adhering of the metallic layer 110 to the substrate 106. As a non-limiting example, the adhesive layer and/or film layer 112 may be deposited on, attached to, or otherwise positioned on the substrate 106, and the metallic layer 110 may be deposited on, plated on, sputtered on, attached to, or otherwise positioned on the adhesive layer and/or film layer 112. In other examples, and discussed below with reference to FIGS. 3-14, a plurality of adhesive layers and/or film layers 112 may be utilized. In such embodiments, each adhesive layer and/or film layer 112 may be an adhesive layer, a film layer, or both.

Optionally, the seam tape, component material, or accessory material 102 includes an inner layer between the epoxy adhesive 108 and the substrate 106. When included, the inner layer may provide an air-tight or gas-tight seal for the seam tape, component material, or accessory material 102. The inner layer may be constructed from various materials or combinations of materials as desired. As non-limiting examples, the inner layer may be a plastic-based layer, a urethane-based layer, a metallic layer, combinations thereof, and/or any other suitable layer allowing the seam tape, component material, or accessory material 102 to be inflated with air or other gases.

FIG. 3 illustrates another example of a seam tape, component material, or accessory material 302 that is substantially similar to the seam tape, component material, or accessory material 102 except that the seam tape, component material, or accessory material 302 includes two adhesive layers and/or film layers 112 between the metallic layer 110 and the substrate 106. In this example, each adhesive layer and/or film layer 112 may be an adhesive layer, a film layer, or both.

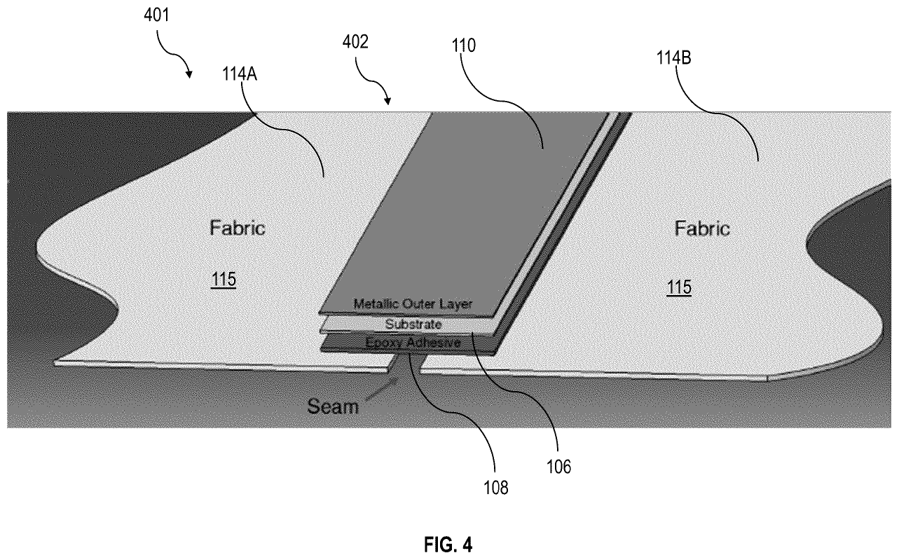

FIG. 4 illustrates another example of an inflatable safety product 401 according to embodiments. The inflatable safety product 401 is similar to the inflatable safety product 101 and includes a seam tape, component material, or accessory material 402 adhered to one or more fabric or flexible composite material panels 114. The seam tape, component material, or accessory material 402 is similar to the seam tape, component material, or accessory material 102 except that the seam tape, component material, or accessory material 402 omits the adhesive layer and/or film layer 112, and the stack of layers forming the seam tape, component material, or accessory material 402 includes the substrate 106, the epoxy adhesive 108 on one side of the substrate 106, and the metallic layer 110 on a side of the substrate 106 opposite from the epoxy adhesive 108. In FIG. 4, the seam tape, component material, or accessory material 402 is illustrated as being adhered to the outer surface 115 of the fabric or flexible composite material panels 114.

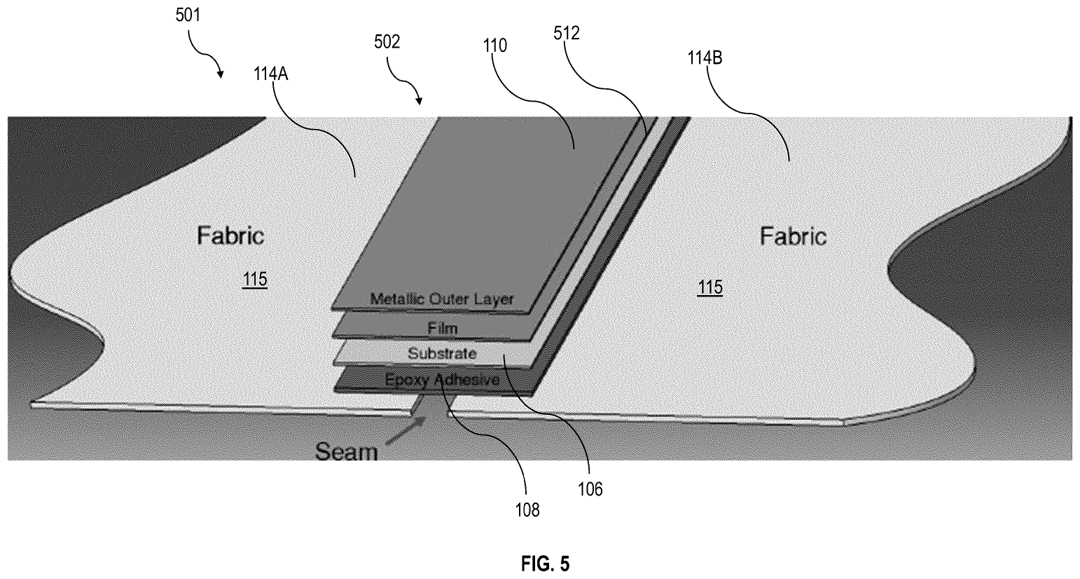

FIG. 5 illustrates another example of an inflatable safety product 501 according to embodiments. The inflatable safety product 501 is similar to the inflatable safety product 101 and includes a seam tape, component material, or accessory material 502 adhered to one or more fabric or flexible composite material panels 114. The seam tape, component material, or accessory material 502 is similar to the seam tape, component material, or accessory material 102 except that the seam tape, component material, or accessory material 502 includes a film layer 512 (adhesive layer and/or film layer 112), and the stack of layers forming the seam tape, component material, or accessory material 502 includes the substrate 106, the epoxy adhesive 108 on one side of the substrate 106, the metallic layer 110 on a side of the substrate 106 opposite from the epoxy adhesive 108, and the film layer 512 between the metallic layer 110 and the substrate 106. In FIG. 5, the seam tape, component material, or accessory material 502 is illustrated as being adhered to the outer surface 115 of the fabric or flexible composite material panels 114.

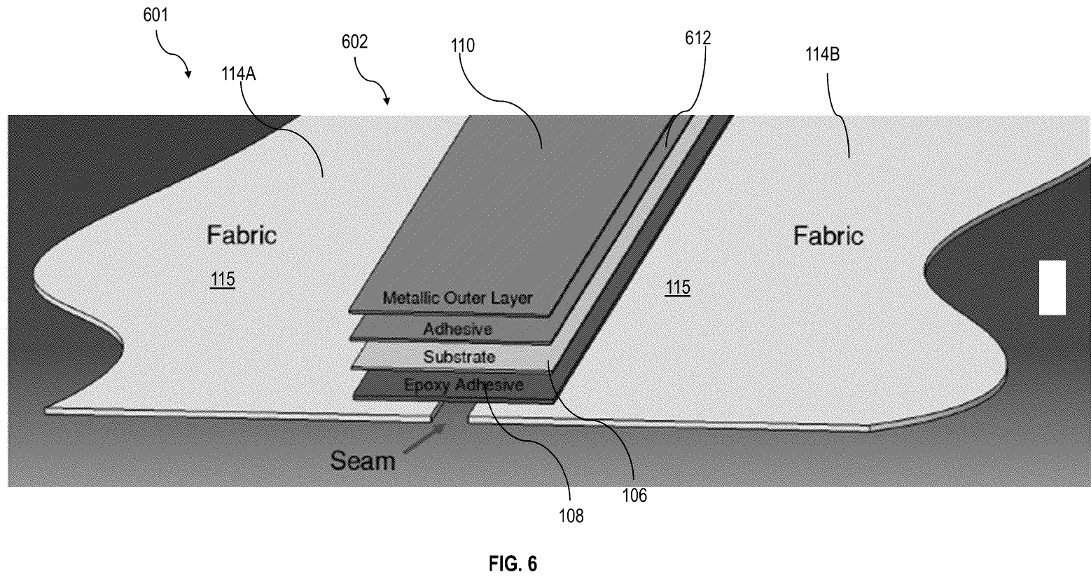

FIG. 6 illustrates another example of an inflatable safety product 601 according to embodiments. The inflatable safety product 601 is similar to the inflatable safety product 101 and includes a seam tape, component material, or accessory material 602 adhered to one or more fabric or flexible composite material panels 114. The seam tape, component material, or accessory material 602 is similar to the seam tape, component material, or accessory material 102 except that the seam tape, component material, or accessory material 602 includes an adhesive layer 612 (similar to the adhesive layer and/or film layer 112). In this example, the stack of layers forming the seam tape, component material, or accessory material 602 includes the substrate 106, the epoxy adhesive 108 on one side of the substrate 106, the metallic layer 110 on a side of the substrate 106 opposite from the epoxy adhesive 108, and the adhesive layer 612 between the metallic layer 110 and the substrate 106. In FIG. 6, the seam tape, component material, or accessory material 602 is illustrated as being adhered to the outer surface 115 of the fabric or flexible composite material panels 114.

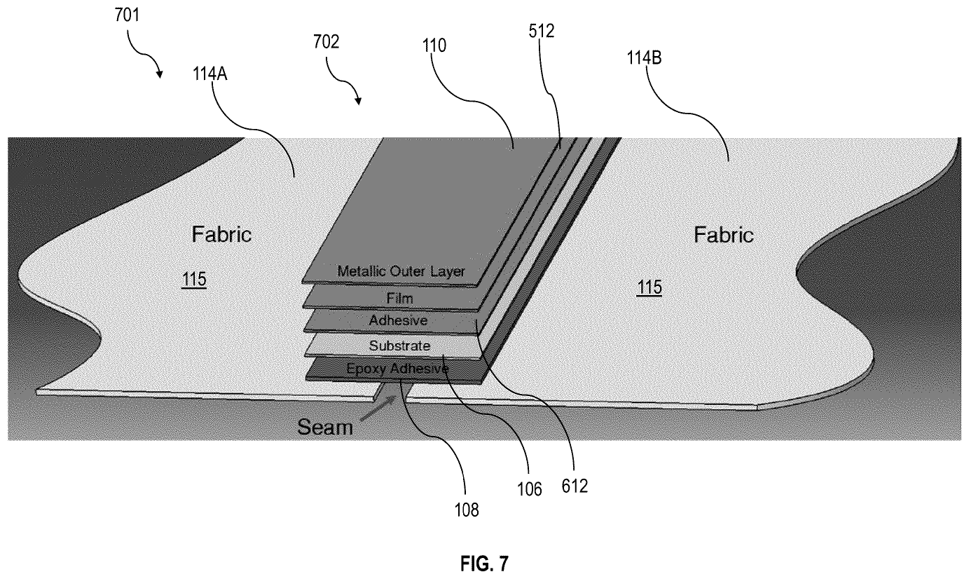

FIG. 7 illustrates another example of an inflatable safety product 701 according to embodiments. The inflatable safety product 701 is similar to the inflatable safety product 101 and includes a seam tape, component material, or accessory material 702 adhered to one or more fabric or flexible composite material panels 114. The seam tape, component material, or accessory material 702 is similar to the seam tape, component material, or accessory material 102 except that the seam tape, component material, or accessory material 702 includes two adhesive layer and/or film layers 112 where one is the adhesive layer 612 and the other is the film layer 512. In this example, the stack of layers forming the seam tape, component material, or accessory material 702 includes the substrate 106, the epoxy adhesive 108 on one side of the substrate 106, the metallic layer 110 on a side of the substrate 106 opposite from the epoxy adhesive 108, and the film layer 512 between the metallic layer 110 and the substrate 106, and the adhesive layer 612 between the film layer 512 and the substrate 106. In FIG. 7, the seam tape, component material, or accessory material 702 is illustrated as being adhered to the outer surface 115 of the fabric or flexible composite material panels 114.

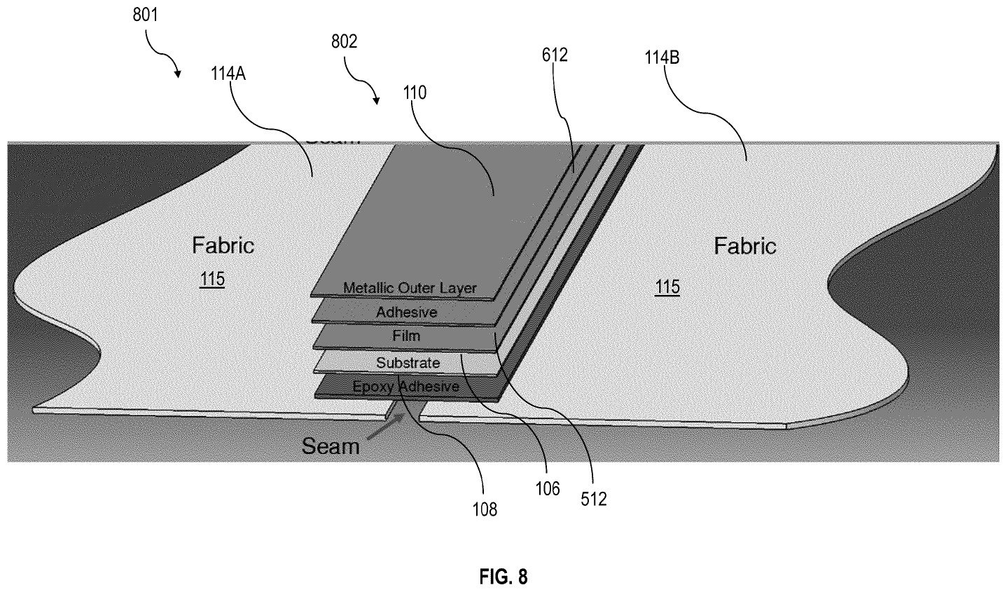

FIG. 8 illustrates another example of an inflatable safety product 801 according to embodiments. The inflatable safety product 801 is similar to the inflatable safety product 101 and includes a seam tape, component material, or accessory material 802 adhered to one or more fabric or flexible composite material panels 114. The seam tape, component material, or accessory material 802 is similar to the seam tape, component material, or accessory material 102 except that the seam tape, component material, or accessory material 802 includes two adhesive layer and/or film layers where one is the adhesive layer 612 and the other is the film layer 512. In this example, the stack of layers forming the seam tape, component material, or accessory material 702 includes the substrate 106, the epoxy adhesive 108 on one side of the substrate 106, the metallic layer 110 on a side of the substrate 106 opposite from the epoxy adhesive 108, and the film layer 512 between the metallic layer 110 and the substrate 106, and the adhesive layer 612 between the film layer 512 and the metallic layer 110. In FIG. 8, the seam tape, component material, or accessory material 702 is illustrated as being adhered to the outer surface 115 of the fabric or flexible composite material panels 114.

FIG. 9 illustrates another example of an inflatable safety product 901 according to embodiments. The inflatable safety product 901 is similar to the inflatable safety product 101 and includes a seam tape, component material, or accessory material 902 adhered to one or more fabric or flexible composite material panels 114. The seam tape, component material, or accessory material 902 is similar to the seam tape, component material, or accessory material 102 except that the seam tape, component material, or accessory material 902 includes a top layer 916. In this example, the stack of layers forming the seam tape, component material, or accessory material 902 includes the substrate 106, the epoxy adhesive 108 on one side of the substrate 106, the metallic layer 110 on a side of the substrate 106 opposite from the epoxy adhesive 108, and the top layer 916 on the metallic layer 110. As previously mentioned, the top layer 916 may include a thin film layer, coating, or other suitable layer that can prevent damage, inhibit corrosion, and/or inhibit oxidation, may minimize or prevent deterioration due to hydrolysis, may promote adhesion to seam tapes, girt materials, floor materials, sliding surface materials, patch material, component materials, accessory materials or other materials, may increase the durability of the metallic layer, fabric, or flexible composite material, etc. In FIG. 9, the seam tape, component material, or accessory material 902 is illustrated as being adhered to the outer surface 115 of the fabric or flexible composite material panels 114.

FIG. 10 illustrates another example of an inflatable safety product 1001 according to embodiments. The inflatable safety product 1001 is similar to the inflatable safety product 601 and includes a seam tape, component material, or accessory material 1002 adhered to one or more fabric or flexible composite material panels 114. The seam tape, component material, or accessory material 1002 is similar to the seam tape, component material, or accessory material 602 except that the seam tape, component material, or accessory material 1002 additionally includes the adhesive layer 612. In this example, the stack of layers forming the seam tape, component material, or accessory material 1002 includes the substrate 106, the epoxy adhesive 108 on one side of the substrate 106, the metallic layer 110 on a side of the substrate 106 opposite from the epoxy adhesive 108, the top layer 916 on the metallic layer 110, and the adhesive layer 612 between the metallic layer 110 and the substrate 106. In FIG. 10, the seam tape, component material, or accessory material 1002 is illustrated as being adhered to the outer surface 115 of the fabric or flexible composite material panels 114.

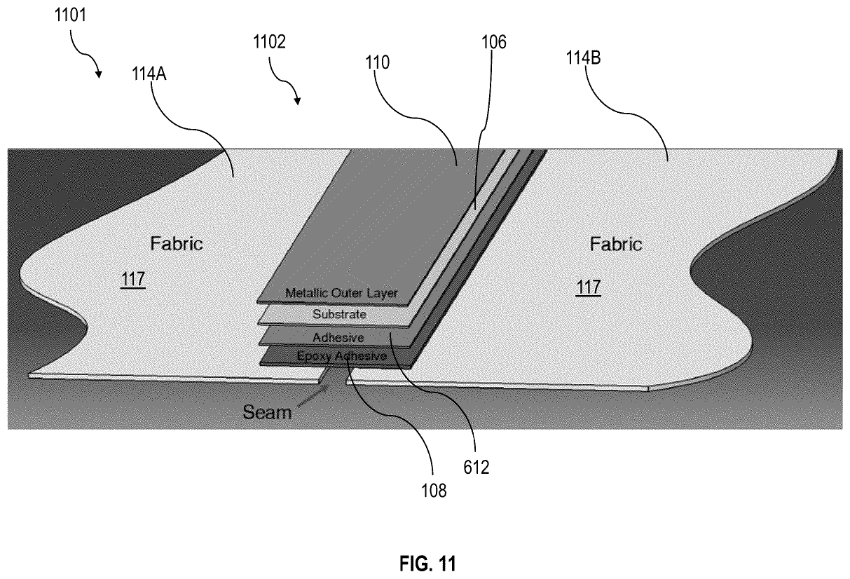

FIG. 11 illustrates another example of an inflatable safety product 1101 according to embodiments. The inflatable safety product 1101 is similar to the inflatable safety product 101 and includes a seam tape, component material, or accessory material 1102 adhered to one or more fabric or flexible composite material panels 114. The seam tape, component material, or accessory material 1102 is similar to the seam tape, component material, or accessory material 102 except that the seam tape, component material, or accessory material 1102 includes the adhesive layer 612. In this example, the stack of layers forming the seam tape, component material, or accessory material 1102 includes the substrate 106, the epoxy adhesive 108 on one side of the substrate 106, the metallic layer 110 on a side of the substrate 106 opposite from the epoxy adhesive 108, and the adhesive layer 612 between the epoxy adhesive 108 and the substrate 106. In FIG. 11, the seam tape, component material, or accessory material 1102 is illustrated as being adhered to the inner surface 117 of the fabric or flexible composite material panels 114.

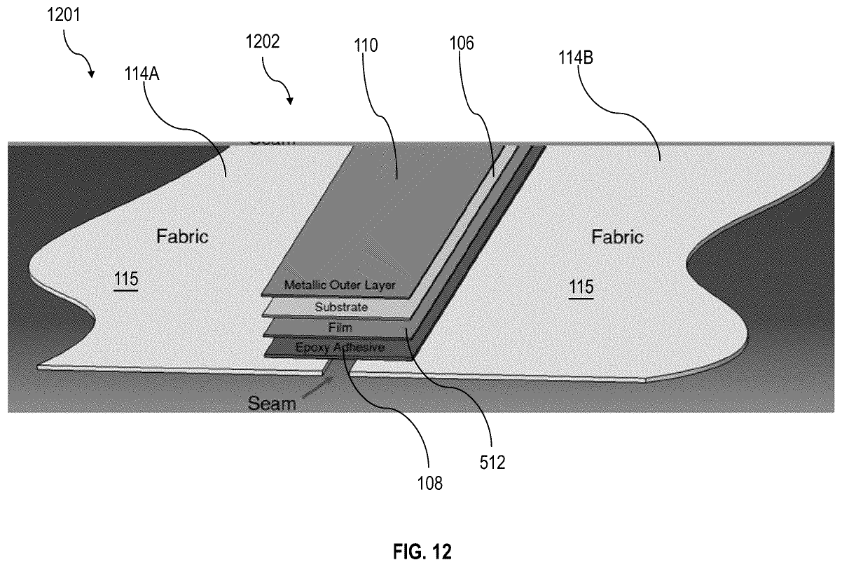

FIG. 12 illustrates another example of an inflatable safety product 1201 according to embodiments. The inflatable safety product 1201 is similar to the inflatable safety product 101 and includes a seam tape, component material, or accessory material 1202 adhered to one or more fabric or flexible composite material panels 114. The seam tape, component material, or accessory material 1202 is similar to the seam tape, component material, or accessory material 102 except that the seam tape, component material, or accessory material 1202 includes the film layer 512. In this example, the stack of layers forming the seam tape, component material, or accessory material 1202 includes the substrate 106, the epoxy adhesive 108 on one side of the substrate 106, the metallic layer 110 on a side of the substrate 106 opposite from the epoxy adhesive 108, and the film layer 512 between the epoxy adhesive 108 and the substrate 106. In FIG. 12, the seam tape, component material, or accessory material 1202 is illustrated as being adhered to the outer surface 115 of the fabric or flexible composite material panels 114.

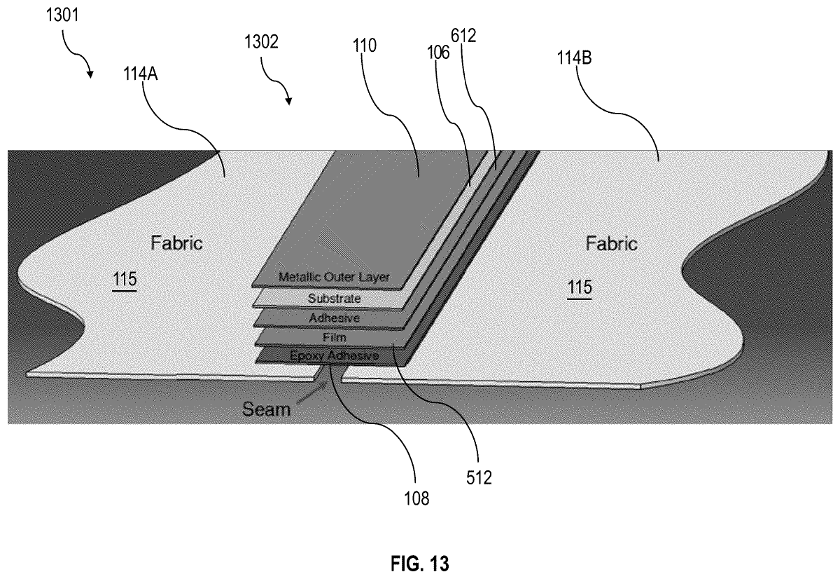

FIG. 13 illustrates another example of an inflatable safety product 1301 according to embodiments. The inflatable safety product 1301 is similar to the inflatable safety product 101 and includes a seam tape, component material, or accessory material 1302 adhered to one or more fabric or flexible composite material panels 114. The seam tape, component material, or accessory material 1302 is similar to the seam tape, component material, or accessory material 102 except that the seam tape, component material, or accessory material 1302 includes the film layer 512 and the adhesive layer 612. In this example, the stack of layers forming the seam tape, component material, or accessory material 1302 includes the substrate 106, the epoxy adhesive 108 on one side of the substrate 106, the metallic layer 110 on a side of the substrate 106 opposite from the epoxy adhesive 108, the film layer 512 between the epoxy adhesive 108 and the substrate 106, and the adhesive layer 612 between the film layer 512 and the substrate 106. In FIG. 13, the seam tape, component material, or accessory material 1302 is illustrated as being adhered to the outer surface 115 of the fabric or flexible composite material panels 114.

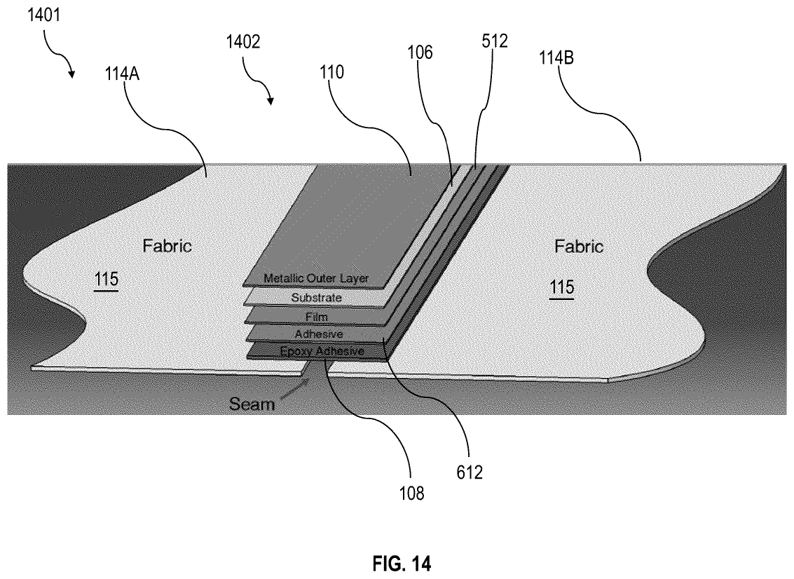

FIG. 14 illustrates another example of an inflatable safety product 1401 according to embodiments. The inflatable safety product 1401 is similar to the inflatable safety product 101 and includes a seam tape, component material, or accessory material 1402 adhered to one or more fabric or flexible composite material panels 114. The seam tape, component material, or accessory material 1402 is similar to the seam tape, component material, or accessory material 102 except that the seam tape, component material, or accessory material 1402 includes the film layer 512 and the adhesive layer 612. In this example, the stack of layers forming the seam tape, component material, or accessory material 1402 includes the substrate 106, the epoxy adhesive 108 on one side of the substrate 106, the metallic layer 110 on a side of the substrate 106 opposite from the epoxy adhesive 108, the film layer 512 between the epoxy adhesive 108 and the substrate 106, and the adhesive layer 612 between the film layer 512 and the epoxy adhesive 108. In FIG. 14, the seam tape, component material, or accessory material 1402 is illustrated as being adhered to the outer surface 115 of the fabric or flexible composite material panels 114.

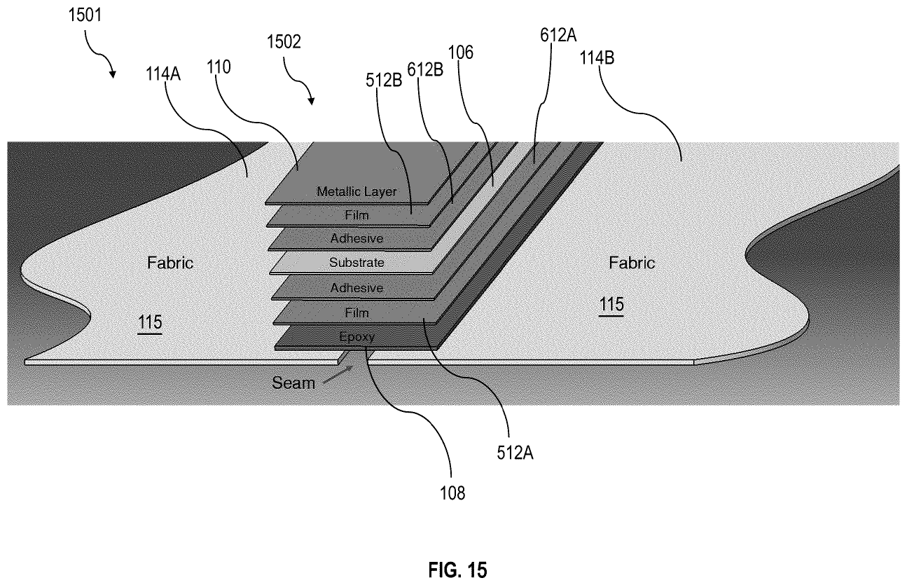

FIG. 15 illustrates another example of an inflatable safety product 1501 according to embodiments. The inflatable safety product 1501 is similar to the inflatable safety product 101 and includes a seam tape, accessory material, or component material 1502 adhered to one or more fabric or flexible composite material panels 114. The seam tape, accessory material, or component material 1402 is similar to the seam tape, accessory material, or component material 102 except that the seam tape, accessory material, or component material 1402 includes a plurality of film layers 512 and a plurality of adhesive layers 612. In this example, the stack of layers forming the seam tape, accessory material, or component material 1502 includes the substrate 106, the epoxy adhesive 108 on one side of the substrate 106, the metallic layer 110 on a side of the substrate 106 opposite from the epoxy adhesive 108, a first film layer 512A between the epoxy adhesive 108 and the substrate 106, a first adhesive layer 612A between the first film layer 512A and the epoxy adhesive 108, a second film layer 512B between the substrate 106 and the metallic layer 110, and a second adhesive layer 612B between the substrate 106 and the second film layer 512B. In FIG. 15, the seam tape, accessory material, or component material 1502 is illustrated as being adhered to the outer surface 115 of the fabric or flexible composite material panels 114.

In other examples, the above embodiments of the seam tape, component material, or accessory material can be adhered to the inner surface of the inflatable safety product panel or panels. These examples may be used with or without the metallic layer.

As mentioned, a method of adhering a seam tape, component material, or accessory material to a fabric or flexible composite material of an inflatable product may include applying an epoxy adhesive onto a seam tape, component material, or accessory material. Optionally, the method may include partially curing the epoxy adhesive. Optionally, the method may include maintaining the seam tape, component material, or accessory material with the epoxy adhesive at a low temperature (or freezing) to slow and/or stop a curing process. The method may include positioning the seam tape, component material, or accessory material with epoxy adhesive onto the fabric or flexible composite material panel(s) of the inflatable safety product, and applying heat and pressure to the seam tape, component material, or accessory material to adhere the seam tape, component material, or accessory material to the fabric or flexible composite material panel(s). The method may include curing the epoxy adhesive after applying the heat and pressure. As mentioned, in certain embodiments, providing the seam tape, component material, or accessory material on the fabric or flexible composite material panel(s) having a metallic surface and/or an emissivity of less than or equal to 0.48, such as less than or equal to 0.25.

As mentioned, the seam tapes, patch material, component materials, or accessory materials described herein may be used for various inflatable products and/or accessories for inflatable products as desired. As non-limiting examples, the material described herein may be a material for a seam tape joining panels of an inflatable safety product such as but not limited to an inflatable evacuation slide, inflatable evacuation slide/raft, inflatable evacuation ramp, inflatable evacuation slide/ramp, inflatable life raft, inflatable life vest, or inflatable helicopter floats, among others. As another non-limiting example, the material described herein may be material for an accessory or component such as but not limited to a patch, girt, handle, structural attachment, or pouch.

### FAA Requirements

In various embodiments, the fabric or flexible composite material described herein may meet and/or exceeds the fabric or flexible composite material requirements according to TSO-C69c from the Federal Aviation Administration (FAA), entitled EMERGENCY EVACUATION SLIDES, RAMPS, RAMP/SLIDES, AND SLIDE RAFTS and published Aug. 18, 1999 (“TSO-C69c”) (incorporated herein by reference), TSO-C13f from the FAA, entitled LIFE PRESERVERS and published Sep. 24, 1992 (“TSO-C13f”) (incorporated herein by reference), and/or TSO-C70b from the FAA, entitled LIFE RAFTS and published Aug. 4, 2014 (“TSO-C70b”) (incorporated herein by reference).

Required tests include: seam peel strength, seam shear strength, tensile strength (grab test), tear strength (trapezoid test), tear strength (tongue test), ply adhesion, coat adhesion, temperature resistance, radiant heat resistance, puncture strength, tear propagation, chafe resistance, flammability (vertical burn rate), pressure retention, permeability, porosity (hydrolysis), hydrolysis conditioning, resistance to hydrolysis, fluids exposure, and accelerated aging

### Seam Adhesion

### TSO-C69c Requirement

As a non-limiting example, the fabric or flexible composite material adhered or welded to the fabric or flexible composite material of the inflatable safety product creating a seam region, when separated from the fabric or flexible composite material of the inflatable safety product, at or about a 1800 angle, at a separation rate of between 2 and 2.5 inches/minute, at a temperature between 70° F. to 72° F., wherein the average of at least 5 specimens must resist separation with a force of 5 pounds/inch width or greater. The aforementioned resistance to separation, described herein peel strength as referenced in TSOs, such as but not limited to TSO-C69c from the FAA.

As a further non-limiting example, any coatings, films, or layers applied to the substrate of the fabric or flexible composite material, when separated from the substrate or other layers used in the construction of the fabric or flexible composite material, of the inflatable safety product, at or about a 180° angle, at a separation rate of between 2 and 2.5 inches/minute, at a temperature of between 70° F. to 72° F., wherein the average of at least 5 specimens must resist separation with a force of 5 pounds/inch width or greater. The aforementioned resistance to separation, described herein ply adhesion and coating adhesion as referenced in TSOs, such as but not limited to TSO-C69c from the FAA.

### Seam Shear

### TSO-C69c Requirement

As a non-limiting example, the fabric or flexible composite material adhered or welded to the fabric or flexible composite material of the inflatable safety product creating a seam region, when used to create a specimen of the seam region and with the fabric or flexible composite material adhered or welded with a ¾ inch maximum overlap, at a separation rate between 11.5 and 12.5 inches/minute, at a temperature of 75° F., wherein the average of at least 3 specimens must resist separation with a force of 175 pounds/inch width or greater when pulled in the shear direction.

As a further non-limiting example, the fabric or flexible composite material adhered or welded to the fabric or flexible composite material of the inflatable safety product creating a seam region, when used to create a specimen of seam region 2 inches in length and with the fabric or flexible composite material adhered or welded at a ¾ inch maximum overlap, at a separation rate of between 11.5 and 12.5 inches/minute, at a temperature of 140° F., wherein the average of at least 3 specimens must resist separation with a force of 40 pounds/inch width or greater when the pulled in the shear direction. The aforementioned resistance to separation, describes shear strength as referenced in TSOs, such as but not limited to TSO-C69c from the FAA.

### Tensile and Tear Strength

### TSO-C69c Requirement

As a non-limiting example, the fabric or flexible composite material of the inflatable safety product, when at least 5 specimens prepared as per Federal Test Method Standard—Method 5134 (Tongue Test), are placed between 2 jaws that are 3 inches apart and subjected to a separation rate of between 11.5 and 12.5 inches/minute, at a temperature of 68° F. to 72° F., must a resist separation with a maximum force of an average of at least 13 pounds/inch in warp direction and fill direction (along the manufacturing length and width of the fabric or flexible composite material).

As a non-limiting example, the fabric or flexible composite material of the inflatable safety product, when at least 5 specimens prepared as per Federal Test Method Standard—Method 5136 (Trapezoid Test), are placed between 2 jaws that are 1 inch apart and subjected to a separation rate of between 11.5 and 12.5 inches/minute, at a temperature of 68° F. to 72° F., must a resist separation with a maximum force of an average of at least 13 pounds/inch in warp direction and fill direction (along the manufacturing length and width of the fabric or flexible composite material).

As a further non-limiting example, after aging (exposed to a temperature of 158±4° F. for not less than 168 hours), the fabric or flexible composite of the inflatable safety product, when at least 5 specimens prepared as per Federal Test Method Standard—Method 5134 (Tongue Test), are placed between 2 jaws that are 3 inches apart and subjected to a separation rate of between 11.5 and 12.5 inches/minute, at a temperature of 68° F. to 72° F., must a resist separation with a maximum force of an average of at least 13 pounds/inch in warp direction and fill direction (along the manufacturing length and width of the fabric or flexible composite material).

As a further non-limiting example, after aging, the fabric or flexible composite material of the inflatable safety product, when at least 5 specimens prepared as per Federal Test Method Standard—Method 5136 (Trapezoid Test), are placed between 2 jaws that are 1 inch apart and subjected to a separation rate between 11.5 and 12.5 inches/minute, at a temperature of 68° F. to 72° F., must a resist separation with a maximum force of an average of at least 13 pounds/inch in warp direction and fill direction (along the manufacturing length and width of the fabric or flexible composite material).

As a non-limiting example, the fabric or flexible composite material of the inflatable safety product, when at least 5 specimens prepared as per Federal Test Method Standard—Method 5100 (Grab Test), are placed between 2 jaws that are 3 inches apart and subjected to a separation rate between 11.5 and 12.5 inches/minute, at a temperature of 68° F. to 72° F., must resist separation with a maximum force of an average of at least 190 pounds/inch in warp direction and fill direction (along the manufacturing length and width of the fabric or flexible composite material).

As a further non-limiting example, after aging, the fabric or flexible composite material of the inflatable safety product, when at least 5 specimens prepared as per Federal Test Method Standard—Method 5100 (Grab Test), are placed between 2 jaws that are 3 inches apart and subjected to a separation rate between 11.5 and 12.5 inches/minute, at a temperature of 68° F. to 72° F., must a resist separation with a maximum force of an average of at least 190 pounds/inch in warp direction and fill direction (along the manufacturing length and width of the fabric or flexible composite material).

### Air Holding & Gas Holding

### TSO-C69c Requirement

As a non-limiting example, the fabric or flexible composite material, described herein when configured into an inflatable safety product must withstand a pressure of at least 1.5 times the maximum operating pressure for at least 5 minutes of its intended use.

As a further non-limiting example, the fabric or flexible composite material, described herein when configured into an inflatable safety product must withstand a pressure of at least 2 times the maximum operating pressure for at least 1 minute, of its intended use.

As a further non-limiting example, the fabric or flexible composite material, described herein when configured into an inflatable safety inflatable safety product, when inflated to its operating pressure of intended use must not fall below at least 50 percent of its initial pressure in a period less than 12 hours.

As a further non-limiting example, the fabric or flexible composite material, described herein when configured into an inflatable safety product, that is capable of being used as a life raft or flotation device when inflated to its operating pressure of intended use must not fall below the minimum raft mode operating pressure in less than 24 hours.

### Helium Permeability

### TSO-C69c Requirement

As a non-limiting example, the fabric or flexible composite material of the inflatable safety product, when at least 3 specimens are prepared and tested as per Federal Test Method Standard—Method 5460 or ASTM Method D1434-82, Procedure V, have a maximum permeability of Helium of 10 liters per square meter in 24 hours at 77° F. or its equivalent in Hydrogen when a pressure is applied to the chamber on the side of the test specimen that separates the test gas (Helium or its equivalent in Hydrogen) from the chamber receiving the permeating gas.

### Temperature Resistance

### TSO-C69c Requirement:

As a non-limiting example, the fabric or flexible composite material, seam tape, accessory material and or product accessories described herein when exposed to temperatures from −40° F. to 160° F. must remain fully functioning per its intended use as referenced in TSOs, such as but not limited to TSO-C69c from the FAA.

As a further non-limiting example, the fabric or flexible composite material, seam tape, accessory material and or product accessories described herein must remain fully functioning per its intended use after exposure to a storage temperature of 185° F. or greater as referenced in TSOs, such as but not limited to TSO-C69c from the FAA.

As a further non-limiting example, the fabric or flexible composite material, seam tape, accessory material and or product accessories described herein must remain fully functioning per its intended use after being stowed at a temperature −65° F. or less as referenced in TSOs, such as but not limited to TSO-C69c from the FAA.

### Radiant Heat Resistance

### TSO-C69c Requirement

As a further non-limiting example, the fabric or flexible composite material described herein when exposed to a radiant heat flux of 1.5 Btu/ft²-sec or greater, wherein a pressure applied to the surface opposite the heat source does not decrease for at least 90 seconds when the surface opposite the heat source is subjected to a higher pressure than the surface subjected to the heat source, wherein the average of the time to pressure decrease of at least 3 specimens of the fabric or flexible composite is at least 180 seconds or greater.

### Fluids Exposure

### TSO-C70b Requirement

As a further non-limiting example, the fabric or flexible composite material described herein must be capable of withstanding the detrimental effects of exposure to fuels, oils, hydraulic fluids, and sea water. After being exposed to fuels, oils, hydraulic fluids, and sea water, a seam will not have a decrease in seam strength or coat adhesion of more than 10%.

As a further non-limiting example, the fabric or flexible composite material, described herein must remain capable of withstanding the detrimental effects of exposure to fuels, oils, hydraulic fluids, and sea water with no loss in air holding or gas holding properties. After being exposed to fuels, oils, hydraulic fluids, and sea water, the fabric or flexible composite material, wherein the average of at least 5 specimens in warp direction and fill direction (along the manufacturing length and width of the fabric or flexible composite material) will not have a decrease in coating adhesion, ply adhesion, peel strength, seam shear strength, tensile strength, or tear strength of more than 10% as referenced in TSOs, such as but not limited to TSO-C70b from the FAA.

### Hydrolysis

### TSO-C69c Requirement

As a further non-limiting example, the fabric or flexible composite material, described herein must remain capable of withstanding the detrimental effects of hydrolysis exposure to a temperature of 136±4° F. at a relative humidity of 95±4 percent for a period of 50 days with no loss in air holding or gas holding properties. After hydrolysis exposure to a temperature of 136±4° F. at a relative humidity of 95±4 percent for a period of 50 days the fabric or flexible composite material, wherein the average of at least 5 specimens in warp direction and fill direction (along the manufacturing length and width of the fabric or flexible composite material) will not have a decrease in coating adhesion, ply adhesion, peel strength, seam shear strength, tensile strength, or tear strength of more than 20% as referenced in TSOs, such as but not limited to TSO-C69c from the FAA.

### Tear Propagation

### TSO-C69c Requirement

As a non-limiting example, the fabric or flexible composite material, described herein when must not allow a tear to propagate beyond the implement that caused an initial puncture or tear as referenced in TSOs, such as but not limited to TSO-C69c from the FAA.

### Accelerated Aging

### TSO-C69c Requirement

As a further non-limiting example, the fabric or flexible composite material, described herein must remain capable of withstanding the detrimental effects of accelerated aging at a temperature of 158±4° F. for not less than 168 hours with no loss in air holding or gas holding properties. After accelerated aging at a temperature of 158±4° F. for not less than 168 hours the fabric or flexible composite material, seam tape, accessory material wherein the average of at least 5 specimens in warp direction and fill direction (along the manufacturing length and width of the fabric or flexible composite material) will not have a decrease in coating adhesion, ply adhesion, peel strength, seam shear strength, tensile strength, or tear strength of more than 10% as referenced in TSOs, such as but not limited to TSO-C69c from the FAA.

### Flammability

### TSO-C69c Requirement

As a non-limiting example, the fabric or flexible composite material, described herein, wherein the average of at least 3 specimens in warp direction and fill direction (along the manufacturing length and width of the fabric or flexible composite material material) are located ¾ inches above the top edge of a burner apparatus, for a period of 12 seconds is exposed to a flame with a total length of 1.5 inches and an inner cone length of ⅞ inches, and minimum temperature of 1550° F., shall not burn for more than 15 seconds after the flame is removed, shall not burn more than 8 inches in the vertical direction, wherein any material that drips form the specimen shall not burn to more than 5 seconds, as referenced such as but not limited to the flammability requirements of 14 CFR part 25.853(a), Appendix F, Part I (a)(1)(ii) as referenced in TSOs, such as but not limited to TSO-C69c from the FAA.

### EXAMPLES

A collection of exemplary embodiments is provided below, including at least some explicitly enumerated as “Examples” providing additional description of a variety of example embodiments in accordance with the concepts described herein. These illustrations are not meant to be mutually exclusive, exhaustive, or restrictive; and the disclosure not limited to these example illustrations but rather encompasses all possible modifications and variations within the scope of the issued claims and their equivalents.

Example 1. A seam tape, component material, or accessory material for an inflatable safety product, the seam tape, component material, or accessory material comprising an epoxy adhesive to adhere the seam tape, component material, or accessory material to a fabric or flexible composite material of the inflatable safety product.

Example 2. The seam tape, component material, or accessory material of the preceding or subsequent examples or combination of examples, wherein the seam tape, component material, or accessory material comprises a substrate with a metallic layer covering at least one surface of the substrate.

Example 3. The seam tape, component material, or accessory material of the preceding or subsequent examples or combination of examples, wherein the fabric or flexible composite material of the inflatable safety product comprises a metallic layer and the epoxy adhesive adheres the seam tape, component material, or accessory material to the metallic layer.

Example 4. The fabric or flexible composite material of the inflatable safety product of the preceding or subsequent examples or combination of examples, wherein the metallic layer is covered by an exterior layer to prevent damage, oxidation and/or corrosion of the metallic layer.

Example 5. The fabric or flexible composite material of the inflatable safety product of the preceding or subsequent examples or combination of examples wherein the metallic layer is covered by an exterior layer to prevent deterioration of the fabric or flexible composite material due to hydrolysis.

Example 6. The fabric or flexible composite material of the inflatable safety product of the preceding or subsequent examples or combination of examples, wherein the metallic layer is covered by an exterior layer to promote adhesion to the metallic layer.

Example 7. The fabric or flexible composite material of the inflatable safety product of the preceding or subsequent examples or combination of examples, wherein the metallic layer is covered by an exterior layer to improve a durability of the metallic layer.

Example 8. The seam tape, component material, or accessory material of the preceding or subsequent examples or combination of examples, wherein the fabric or flexible composite material of the inflatable safety product comprises a non-metallic surface and the epoxy adhesive adheres the seam tape, component material, or accessory material to the non-metallic surface.

Example 9. The seam tape, component material, or accessory material of the preceding or subsequent examples or combination of examples, wherein the epoxy adhesive maintains seam adhesion when exposed to a heat source, aging, or fluids exposure.

Example 10. The seam tape, component material, or accessory material of the preceding or subsequent examples or combination of examples, wherein the epoxy adhesive is solids-based, solvent-based, or water-based.

Example 11. The seam tape, component material, or accessory material of the preceding or subsequent examples or combination of examples, wherein the fabric or flexible composite material of the inflatable safety product comprises at least one of a polyethylene substrate, a metallic surface, or an emissivity value of 0.48 or less.

Example 12. The seam tape, component material, or accessory material of the preceding or subsequent examples or combination of examples, wherein the seam tape, component material, or accessory material comprises an emissivity value of 0.48 or less.

Example 13. The seam tape, component material, or accessory material of the preceding or subsequent examples or combination of examples, wherein the fabric or flexible composite material of the inflatable safety product comprises an emissivity value of 0.48 or less.

Example 14. The seam tape, component material, or accessory material of the preceding or subsequent examples or combination of examples, wherein the seam tape, component material, or accessory material and the fabric or flexible composite material of the inflatable safety product each comprise an emissivity value of 0.48 or less.

Example 15. The seam tape, component material, or accessory material of the preceding or subsequent examples or combination of examples, wherein the seam tape, component material, or accessory material comprises a polyethylene substrate, ultra-high molecular weight polyethylene substrate, polypropylene substrate, polyester substrate, polyamide substrate, aromatic polyamide substrate, aramid substrate, polyolefin substrate, aromatic polyester substrate, polyarylate substrate, other liquid crystal polymers substrate, or nylon substrate.

Example 16. An inflatable safety product comprising: a first panel; a second panel, the first panel and the second panel forming a seam region; and the seam tape of the preceding or subsequent examples or combination of examples, wherein the seam tape joins the first panel and the second panel in the seam region.

Example 17. The inflatable safety product of the preceding or subsequent examples or combination of examples, wherein the inflatable safety product comprises an inflatable evacuation slide, inflatable evacuation slide/raft, inflatable evacuation ramp, inflatable evacuation slide/ramp, inflatable life raft, inflatable helicopter float, inflatable life vest, or helicopter float.

Example 18. The inflatable safety product of the preceding or subsequent examples or combination of examples, wherein the first panel, the second panel, and the seam tape each comprise an emissivity value of 0.48 or less.

Example 19. An accessory or component for an inflatable safety product comprising the accessory or component material of the preceding or subsequent examples or combination of examples, wherein the accessory or component is a floor, sliding surface, patch, girt, handle, structural attachment, or pouch.

Example 20. A seam tape, component material, or accessory material for an inflatable safety product, the seam tape, component material, or accessory material comprising an emissivity of less than or equal to 0.48 and an epoxy adhesive, the epoxy adhesive configured to adhere the seam tape, component material, or accessory material to a fabric or flexible composite material of the inflatable safety product.

Example 21. The seam tape, component material, or accessory material of the preceding or subsequent examples or combination of examples, wherein the fabric or flexible composite material of the inflatable safety product comprises an emissivity of less than or equal to 0.48.

Example 22. The seam tape, component material, or accessory material of the preceding or subsequent examples or combination of examples, where the emissivity is less than or equal to 0.25.

Example 23. A method of constructing an inflatable safety product, the method comprising adhering a seam tape, patch, component, or accessory to at least one panel of the inflatable safety product, wherein the seam tape, patch, component, or accessory comprises an epoxy adhesive adhering the seam tape, patch, component, or accessory to the at least one panel, wherein the seam tape, patch, component, or accessory comprises an emissivity of 0.48 or less.

Example 24. The method of the preceding or subsequent examples or combination of examples, wherein the seam tape, patch, component, or accessory is adhered using heat and pressure.

Example 25. The method of the preceding or subsequent examples or combination of examples, wherein the emissivity is 0.25 or less.

Example 26. The method of the preceding or subsequent examples or combination of examples, wherein the at least one panel comprises a first panel and a second panel, and wherein the method comprises adhering the first panel and the second panel in a seam region formed by the first panel and the second panel using the seam tape.

Example 27. The method of the preceding or subsequent examples or combination of examples, wherein the joined first panel, second panel, and seam tape comprise an emissivity of 0.48 or less.

Example 28. The method of the preceding or subsequent examples or combination of examples, wherein the first panel or the second panel comprises a metallic surface, and wherein the epoxy adhesive adheres the seam tape to the metallic surface.

Example 29. The method of the preceding or subsequent examples or combination of examples, wherein the at least one panel comprises an emissivity of 0.48 or less.

Different arrangements of the components depicted in the drawings or described above, as well as components and steps not shown or described are possible. Similarly, some features and sub-combinations are useful and may be employed without reference to other features and sub-combinations. Embodiments of the invention have been described for illustrative and not restrictive purposes, and alternative embodiments will become apparent to readers of this patent. Accordingly, the present invention is not limited to the embodiments described above or depicted in the drawings, and various embodiments and modifications may be made without departing from the scope of the claims below.

The use of the terms “a” and “an” and “the” and similar referents in the context of describing the invention (especially in the context of the following claims) are to be construed to cover both the singular and the plural, unless otherwise indicated herein or clearly contradicted by context. Directional references such as “up,” “down,” “top,” “bottom,” “left,” “right,” “front,” and “back,” among others, are intended to refer to the orientation as illustrated and described in the figure (or figures) to which the components and directions are referencing. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, or gradients thereof, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate embodiments of the invention and does not pose a limitation on the scope of the invention unless otherwise claimed. No language in the specification should be construed as indicating any non-claimed element as essential to the practice of the invention.

As used herein, the term “substantially” refers to the complete or nearly complete extent or degree of an action, characteristic, property, state, structure, item, or result. For example, an object that is “substantially” enclosed would mean that the object is either completely enclosed or nearly completely enclosed. The exact allowable degree of deviation from absolute completeness may in some cases depend on the specific context. However, the nearness of completion will be so as to have the same overall result as if absolute and total completion were obtained.

Preferred embodiments of this invention are described herein, including the best mode known to the inventors for carrying out the invention. The invention is susceptible to various modifications and alternative constructions, and certain shown exemplary embodiments thereof are shown in the drawings and have been described above in detail. Variations of those preferred embodiments, within the spirit of the present invention, may become apparent to those of ordinary skill in the art upon reading the foregoing description. The inventors expect skilled artisans to employ such variations as appropriate, and the inventors intend for the invention to be practiced otherwise than as specifically described herein. Accordingly, it should be understood that there is no intention to limit the invention to the specific form or forms disclosed, but on the contrary, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

The foregoing description, for purposes of explanation, used specific nomenclature to provide a thorough understanding of the described embodiments. However, it will be apparent to one skilled in the art that the specific details are not required in order to practice the described embodiments. Thus, the foregoing descriptions of specific embodiments are presented for purposes of illustration and description. They are not intended to be exhaustive or to limit the described embodiments to the precise forms disclosed. It will be apparent to one of ordinary skill in the art that many modifications and variations are possible in view of the above teachings.

1. A seam tape, component material, or accessory material for an inflatable safety product, the seam tape, component material, or accessory material comprising:
a substrate of a flexible composite or fabric material, the substrate comprising a first side and a second side, wherein the substrate comprises polyamide or polyethylene; and
an epoxy adhesive on at least one of the first side or the second side of the substrate, wherein the epoxy adhesive is configured to adhere the seam tape, component material, or accessory material to a fabric or flexible composite material of the inflatable safety product, wherein the inflatable safety product comprises an inflatable evacuation slide, inflatable evacuation slide/raft, inflatable evacuation ramp, inflatable evacuation slide/ramp, inflatable life raft, inflatable helicopter float, or inflatable life vest.

2. The seam tape, component material, or accessory material of claim 1, wherein the seam tape, component material, or accessory material comprises metallic layer covering at least one surface of the substrate.

3. The seam tape, component material, or accessory material of claim 1, wherein fabric or flexible composite material of the fabric or flexible composite material of the inflatable safety product comprises a metallic layer and the epoxy adhesive adheres the seam tape, component material, or accessory material to the metallic layer.

4. The seam tape, component material, or accessory material of claim 3, wherein the metallic layer is covered by an exterior layer to prevent damage, oxidation and/or corrosion of the metallic layer.

5. The seam tape, component material, or accessory material of claim 3, wherein the metallic layer is covered by an exterior layer to prevent deterioration of the fabric or flexible composite material due to hydrolysis.

6. The seam tape, component material, or accessory material of claim 3, wherein the metallic layer is covered by an exterior layer to promote adhesion to the metallic layer.

7. The seam tape, component material, or accessory material of claim 3, wherein the metallic layer is covered by an exterior layer to improve a durability of the metallic layer.

8. The seam tape, component material, or accessory material of claim 1, wherein fabric or flexible composite material of the inflatable safety product comprises a non-metallic surface and the epoxy adhesive adheres the seam tape, component material, or accessory material to the non-metallic surface.

9. The seam tape, component material, or accessory material of claim 1, wherein the epoxy adhesive maintains seam adhesion when exposed to a heat source, aging, or fluids exposure.

10. The seam tape, component material, or accessory material of claim 1, wherein the epoxy adhesive is solids-based.

11. The seam tape, component material, or accessory material of claim 1, wherein the fabric or flexible composite material of the inflatable safety product comprises at least one of a polyethylene substrate, a metallic surface, or an emissivity value of 0.48 or less.

12. The seam tape, component material, or accessory material of claim 1, wherein the seam tape, component material, or accessory material comprises an emissivity value of 0.48 or less.

13. The seam tape, component material, or accessory material of claim 1, wherein the fabric or flexible composite material of the inflatable safety product comprises an emissivity value of 0.48 or less.

14. The seam tape, component material, or accessory material of claim 1, wherein the seam tape, component material, or accessory material and the fabric or flexible composite material of the inflatable safety product each comprise an emissivity value of 0.48 or less.

15. (canceled)

16. An inflatable safety product comprising:
a first panel;
a second panel, the first panel and the second panel forming a seam region; and
the seam tape of claim 1, wherein the seam tape joins the first panel and the second panel in the seam region.

17. (canceled)

18. The inflatable safety product of claim 16, wherein the first panel, the second panel, and the seam tape each comprise an emissivity value of 0.48 or less.

19. An accessory or component for an inflatable safety product comprising the accessory or component material of claim 1, wherein the accessory or component is a patch, girt, handle, structural attachment, or pouch.

20. A seam tape, component material, or accessory material for an inflatable safety product, the seam tape, component material, or accessory material comprising:
a substrate of a flexible composite or fabric material, the substrate comprising a first side and a second side, wherein the substrate comprises polyamide or polyethylene; and
an epoxy adhesive, the epoxy adhesive on at least one of the first side or the second side of the substrate, wherein the epoxy adhesive is configured to adhere the seam tape, component material, or accessory material to a fabric or flexible composite material of the inflatable safety product, wherein the inflatable safety product comprises an inflatable evacuation slide, inflatable evacuation slide/raft, inflatable evacuation ramp, inflatable evacuation slide/ramp, inflatable life raft, inflatable helicopter float, or inflatable life vest, wherein the seam tape, component material, or accessory material for an inflatable safety product, the seam tape, component material, or accessory material comprises an emissivity of less than or equal to 0.48 and.

21. (canceled)

22. The seam tape, component material, or accessory material of claim 20, where the emissivity is less than or equal to 0.25.

23.-29. (canceled)

30. The seam tape, component material, or accessory material of claim 1, wherein the seam tape, component material, or accessory material comprises a peel strength of at least 5 pounds/inch and a shear strength of at least 175 pounds/inch.

31. The seam tape, component material, or accessory material of claim 1, wherein the epoxy adhesive is solvent-based.

32. The seam tape, component material, or accessory material of claim 1, wherein the epoxy adhesive is solvent-free.

33. The seam tape, component material, or accessory material of claim 1, further comprising an inner layer between the epoxy adhesive and the substrate, wherein the inner layer is a gas barrier layer.

34. The seam tape, component material, or accessory material of claim 1, wherein the epoxy adhesive is on the first side of the substrate, wherein the epoxy adhesive is an outmost layer of the seam tape, component material, or accessory material on first second side, and wherein the seam tape, component material, or accessory material further comprises:
a metallic layer on the second side of the substrate opposite from epoxy adhesive, wherein the metallic layer is an outermost layer of the seam tape, component material, or accessory material on the second side.

35. The seam tape, component material, or accessory material of claim 1, wherein the epoxy adhesive is on the first side of the substrate, wherein the epoxy adhesive is an outmost layer of the seam tape, component material, or accessory material on first second side, and wherein the seam tape, component material, or accessory material further comprises:
a metallic layer on the second side of the substrate opposite from epoxy adhesive, wherein the metallic layer is an outermost layer of the seam tape, component material, or accessory material on the second side; and
a film or adhesive layer on the second side of the substrate opposite from epoxy adhesive, wherein the film or adhesive layer is between the metallic layer and the substrate.

36. The seam tape, component material, or accessory material of claim 1, wherein the epoxy adhesive is on the first side of the substrate, wherein the epoxy adhesive is an outmost layer of the seam tape, component material, or accessory material on first second side, and wherein the seam tape, component material, or accessory material further comprises:
a metallic layer on the second side of the substrate opposite from epoxy adhesive, wherein the metallic layer is an outermost layer of the seam tape, component material, or accessory material on the second side;
a film layer on the second side of the substrate opposite from epoxy adhesive, wherein the film layer is between the metallic layer and the substrate; and
an adhesive layer on the second side of the substrate opposite from the epoxy adhesive, wherein the adhesive layer is between the metallic layer and the substrate.

37. The seam tape, component material, or accessory material of claim 1, wherein the epoxy adhesive is on the first side of the substrate, wherein the epoxy adhesive is an outmost layer of the seam tape, component material, or accessory material on first second side, and wherein the seam tape, component material, or accessory material further comprises:
an outside coating on the second side of the substrate opposite from the epoxy adhesive, wherein the outside coating is an outermost layer of the seam tape, component material, or accessory material on the second side; and
a metallic layer on the second side of the substrate opposite from epoxy adhesive, wherein the metallic layer is between the outside coating and the metallic layer.

38. The seam tape, component material, or accessory material of claim 1, wherein the epoxy adhesive is on the first side of the substrate, wherein the epoxy adhesive is an outmost layer of the seam tape, component material, or accessory material on first second side, and wherein the seam tape, component material, or accessory material further comprises:
an outside coating on the second side of the substrate opposite from the epoxy adhesive, wherein the outside coating is an outermost layer of the seam tape, component material, or accessory material on the second side;
a metallic layer on the second side of the substrate opposite from epoxy adhesive, wherein the metallic layer is between the outside coating and the metallic layer; and
an adhesive layer on the second side of the substrate opposite from the epoxy adhesive, wherein the adhesive layer is between the metallic layer and the substrate.

39. The seam tape, component material, or accessory material of claim 1, wherein the epoxy adhesive is on the first side of the substrate, wherein the epoxy adhesive is an outmost layer of the seam tape, component material, or accessory material on first second side, and wherein the seam tape, component material, or accessory material further comprises:
a metallic layer on the second side of the substrate opposite from epoxy adhesive, wherein the metallic layer is an outermost layer of the seam tape, component material, or accessory material on the second side; and
an adhesive or film layer on the first side of the substrate between the epoxy adhesive and the substrate.

40. The seam tape, component material, or accessory material of claim 1, wherein the epoxy adhesive is on the first side of the substrate, wherein the epoxy adhesive is an outmost layer of the seam tape, component material, or accessory material on first second side, and wherein the seam tape, component material, or accessory material further comprises:
a metallic layer on the second side of the substrate opposite from epoxy adhesive, wherein the metallic layer is an outermost layer of the seam tape, component material, or accessory material on the second side;
an adhesive film layer on the first side of the substrate between the epoxy adhesive and the substrate; and
a film layer on the first side of the substrate between the epoxy adhesive and the substrate.

41. The seam tape, component material, or accessory material of claim 1, wherein the epoxy adhesive is on the first side of the substrate, wherein the epoxy adhesive is an outmost layer of the seam tape, component material, or accessory material on first second side, and wherein the seam tape, component material, or accessory material further comprises:
a metallic layer on the second side of the substrate opposite from epoxy adhesive, wherein the metallic layer is an outermost layer of the seam tape, component material, or accessory material on the second side; and
a first adhesive or film layer on the first side of the substrate between the epoxy adhesive and the substrate; and
a second adhesive or film layer on the second side of the substrate between the metallic layer and the substrate.

42. The seam tape, component material, or accessory material of claim 1, wherein the epoxy adhesive is on the first side of the substrate, wherein the epoxy adhesive is an outmost layer of the seam tape, component material, or accessory material on first second side, and wherein the seam tape, component material, or accessory material further comprises:
a metallic layer on the second side of the substrate opposite from epoxy adhesive, wherein the metallic layer is an outermost layer of the seam tape, component material, or accessory material on the second side; and
a first adhesive layer on the first side of the substrate between the epoxy adhesive and the substrate;
a first film layer on the first side of the substrate between the epoxy adhesive and the substrate;
a second adhesive layer on the second side of the substrate between the metallic layer and the substrate; and
a second film layer on the second side of the substrate between the metallic layer and the substrate.
